(19) United States
(12) Patent Application Publication
(10) Pub. No.: US 2023/0245055 A1
(43) Pub. Date: Aug. 3, 2023

(54) METHOD AND APPARATUS OF PROCESSING ORDER INFORMATION, COMPUTER DEVICE AND MEDIUM

(71) Applicants: Beijing Wodong Tianjun Information Technology Co., Ltd., Beijing (CN); Beijing JingDong ShangKe Information Technology Co., Ltd., Beijing (CN)

(72) Inventors: Ningxuan KANG, Beijing (CN); Ye XU, Beijing (CN); Jie ZHU, Beijing (CN); Jiren LU, Beijing (CN); Rui ZHAO, Beijing (CN); Zuojun SHEN, Beijing (CN)

(21) Appl. No.: 17/995,084

(22) PCT Filed: Apr. 14, 2021
(86) PCT No.: PCT/CN2021/087173

§ 371 Date: Sep. 29, 2022

(30) Foreign Application Priority Data
Apr. 14, 2020 (CN) 202010293111.1

(51) Int. Cl. G06Q 10/087; G06Q 10/0834

(52) U.S. Cl. CPC G06Q 10/087; G06Q 10/0834

(57) ABSTRACT

A method of processing order information is provided, including: acquiring order information including information of a designated address and at least one designated item; acquiring warehouse information including inventory information and distribution information of the plurality of warehouses. Then, the order information and the warehouse information are processed using a pre-built optimization model, so as to determine at least one distribution warehouse according to an output result of the optimization model, so that a sum of a first numerical value and a second numerical value is less than or equal to a predetermined value. The first numerical value characterizes a delivery duration to deliver the at least one designated item from the at least one distribution warehouse to the designated address, and the second numerical value characterizes a delivery fee for delivering the at least one designated item from the at least one distribution warehouse to the designated address.

### CROSS-REFERENCE TO RELATED APPLICATION(S)

This application is a Section 371 National Stage Application of international Application No. PCT/GN2021/087173, filed on Apr. 14, 2021, entitled “METHOD AND APPARATUS OF PROCESSING ORDER INFORMATION, COMPUTER DEVICE AND MEDIUM”, which claims priority to Chinese Application No. 202010293111.1, filed on Apr. 14, 2020, the contents of which are incorporated herein by reference in their entireties.

### TECHNICAL FIELD

The present disclosure relates to the field of a computer technology, and more particularly, to a method and apparatus of processing an order information, a computer device and a medium.

### BACKGROUND

With a rapid development of Internet technology and a rapid rise of e-commerce, various e-commerce platforms provide a variety of online commodity trading channels, which may greatly facilitate people's work and life.

E-commerce fulfillment refers to an entire process from an order generation to a user's receipt of ordered items. A merchant may generally set up several delivery centers in or around a service area, and a plurality of warehouses may be set up in each delivery center to store items for sale. A fulfillment decision means that for each order, one or more warehouses are determined as an actual warehouse for the fulfillment, which is also known as a delivery warehouse, from a plurality of candidate warehouses, and a designated item in the order is delivered from a determined delivery warehouse to a delivery address designated in the order. A location, an inventory level, etc. of different warehouses may be different, and storage and delivery costs of different warehouses may also be different. Therefore, a result of the fulfillment decision will directly affect a delivery duration and a delivery fee, thereby affecting a user's shopping experience and a merchant's fulfillment cost.

### SUMMARY

In view of this, embodiments of the present disclosure provide a method and apparatus of processing an order information, a computer device, and a medium.

An aspect of embodiments of the present disclosure provides a method of processing an order information, including: acquiring an order information, wherein the order information includes: an information of a designated address and an information of at least one designated item; acquiring a warehouse information, wherein the warehouse information includes: an inventory information of a plurality of warehouses and a delivery information of the plurality of warehouses. Then, the order information and the warehouse information are processed by using a pre-built optimization model, so as to determine at least one warehouse from the plurality of warehouses as at least one delivery warehouse according to an output result of the optimization model, so that a sum of a first numerical value and a second numerical value is less than or equal to a predetermined value. The first numerical value is used to characterize a delivery duration taken to deliver at least one designated item from the at least one delivery warehouse to the designated address, and the second numerical value is used to characterize a delivery fee for delivering the at least one designated item from the at least one delivery warehouse to the designated address delivery fee.

According to embodiments of the present disclosure, the information of each designated item in the at least one designated item includes: an identification information of each designated item and a demand number for each designated item. The inventory information of each warehouse in the plurality of warehouses includes: an identification information of items stored in each warehouse and a storage number of each item in each warehouse. The delivery information of each warehouse in the plurality of warehouses includes: a desired delivery duration of each warehouse for a plurality of addresses and a desired delivery fee of each warehouse.

According to embodiments of the present disclosure, the optimization model includes a first sub-model. The processing the order information and the warehouse information by using a pre-built optimization model includes: by using the first sub-model: when at least one first-category item exists in the at least one designated item, for each first-category item, determining, from the plurality of warehouses, first candidate warehouses storing the first-category item and having a storage number of the first-category item greater than or equal to the demand number for the first-category item according to the identification information of the first-category item and the demand number for the first-category item, and determining, from the first candidate warehouses, a first candidate warehouse having a shortest desired delivery duration to the designated address, as a pending warehouse for the first-category item; and determining the pending warehouse for each of the at least one first-category item as an output result of the first sub-model.

According to embodiments of the present disclosure, the determining at least one warehouse from the plurality of warehouses as at least one delivery warehouse according to an output result of the optimization model includes: when the pending warehouse for each of the at least one first-category item is the same warehouse, determining the pending warehouse for each of the at least one first-category item as the delivery warehouse for each of the at least one first-category item.

According to embodiments of the present disclosure, the optimization model further includes a second sub-model, the second sub-model is an integer programming model, an objective function of the integer programming model characterizes the sum of the first numerical value and the second numerical value, and the integer programming model includes at least one constraint condition. The processing the order information and the warehouse information by using a pre-built optimization model further includes: when the pending warehouse for each of the at least one first-category item is not the same warehouse, determining at least one warehouse allocation method based on the at least one constraint condition, the order information and the warehouse information, wherein each warehouse allocation method includes: a delivery relationship between the at least one first-category item and at least one of the plurality of warehouses; determining a value range of the first numerical value and the second numerical value based on the at least one warehouse allocation method; calculating a value of the Objective function based on the value range of the first numerical value and the second numerical value; and then determining a warehouse allocation method minimizing the value of the objective function as an output result of the second sub-model.

According to embodiments of the present disclosure, the determining at least one warehouse from the plurality of warehouses as at least one delivery warehouse according to an output result of the optimization model further includes: determining whether a running duration of the second sub-model before acquiring the output result is greater than a predetermined duration; in a case that the running duration of the second sub-model before acquiring the output result is greater than the predetermined duration, determining the pending warehouse for each of the at least one first-category item as the delivery warehouse for each of the at least one first-category item; and in a case that the running duration of the second sub-model before acquiring the output result is not greater than the predetermined duration, determining the delivery warehouse for each of the at least one first-category item according to the output result of the second sub-model.

According to embodiments of the present disclosure, each warehouse allocation method includes: a delivery relationship between the at least one first-category item and M warehouses, wherein M is an integer greater than or equal to 1. The determining a value range of the first numerical value and the second numerical value based on the at least one warehouse allocation method includes: determining the first numerical value for each warehouse allocation method according to the desired delivery duration of each of the M warehouses to the designated address; and determining the second numerical value for each warehouse allocation method according to the desired delivery fee of each of the M warehouses.

According to embodiments of the present disclosure, the at least one constraint condition is used to limit at least one of: a number of the delivery warehouse for each first-category item; the storage number of each first-category item in the delivery warehouse for each first-category item; and a number of first-category items delivered from each warehouse.

According to embodiments of the present disclosure, the optimization model further includes a third sub-model. The processing the order information and the warehouse information by using a pre-built optimization model further includes: by using the third sub-model, when at least one second-category item exists in the at least one designated item, for each second-category item, determining, from the plurality of warehouses, second candidate warehouses storing the second-category item and having a storage number of the second-category item greater than or equal to the demand number for the second-category item according to the identification information of the second-category item and the demand number for the second-category item, and determining, from the second candidate warehouses, a second candidate warehouse having a shortest desired delivery duration to the designated address as a delivery warehouse for the second-category item; and determining the delivery warehouse for each of the at least one second-category item as an output result of the third sub-model.

According to embodiments of the present disclosure, the determining at least one warehouse from the plurality of warehouses as at least one delivery warehouse according to an output result of the optimization model further includes: determining the delivery warehouse for each of the at least one second-category item according to the output result of the third sub-model.

Another aspect of embodiments of the present disclosure provides an apparatus of processing an order information, including: a first acquiring module, a second acquiring module, and a model processing module. The first acquiring module is configured to acquire the order information, wherein the order information includes: an information of a designated address and an information of at least one designated item. The second acquiring module is configured to acquire a warehouse information, wherein the warehouse information includes: an inventory information of a plurality of warehouses and a delivery information of the plurality of warehouses. Then, the model processing module is configured to process the order information and the warehouse information by using a pre-built optimization model, so as to determine at least one warehouse from the plurality of warehouses as at least one delivery warehouse according to an output result of the optimization model, so that a sum of a first numerical value and a second numerical value is less than or equal to a predetermined value. The first numerical value is used to characterize a delivery duration taken to deliver the at least one designated item from the at least one delivery warehouse to the designated address, and the second numerical value is used to characterize a delivery fee for delivering the at least one designated item from the at least one delivery warehouse to the designated address.

Another aspect of embodiments of the present disclosure provides a computer device, including a memory, a processor, and a computer program stored in the memory and executable on the processor, wherein the method is performed when the processor executes the program.

Another aspect of embodiments of the present disclosure provides a computer-readable storage medium having computer-executable instructions stored thereon, wherein the instructions, when executed, perform the method.

Another aspect of embodiments of the present disclosure provides a computer program including computer-executable instructions that, when executed, are used to implement the method.

### BRIEF DESCRIPTION OF THE DRAWINGS

The above and other objectives, features, and advantages of the present disclosure will be clearer through the following description of embodiments of the present disclosure with reference to the accompanying drawings.

FIG. 1 schematically shows an exemplary system architecture to which a method and apparatus of processing an order information according to an embodiment of the present disclosure are applied.

FIG. 2 schematically shows a flowchart of a method of processing an order information according to an embodiment of the present disclosure.

FIG. 3 schematically shows an example flowchart of a method of processing an order information according to another embodiment of the present disclosure.

FIG. 4 schematically shows an example flowchart of a method of processing an order information according to another embodiment of the present disclosure.

FIG. 5 schematically shows a block diagram of an apparatus of processing an order information according to an embodiment of the present disclosure.

FIG. 6 schematically shows a block diagram of a computer device according to an embodiment of the present disclosure.

### DETAILED DESCRIPTION OF EMBODIMENTS

Embodiments of the present disclosure will be described below with reference to the accompanying drawings. It should be understood, however, that these descriptions are merely exemplary and are not intended to limit the scope of embodiments of the present disclosure. In the following detailed description, for convenience of explanation, many specific details are set forth in order to provide a thorough understanding of embodiments of the present disclosure. It will be apparent, however, that one or more embodiments may be practiced without these specific details. In addition, in the following description, descriptions of well-known structures and technologies are omitted to avoid unnecessarily obscuring the concepts of the present disclosure.

The terms used herein are for the purpose of describing particular embodiments only, and are not intended to limit embodiments of the present disclosure. The terms “including”, “containing”, etc. as used herein indicate the presence of features, steps, operations and/or components, but do not preclude the presence or addition of one or more other features, steps, operations or components.

All terms (including technical and scientific terms) used herein have the meaning as commonly understood by those skilled in the art, unless otherwise defined. It should be noted that the terms used herein should be construed to have meanings consistent with the context of the present disclosure and should not be construed in an idealized or overly rigid manner.

When an expression like “at least one of A, B, and C, etc.” is used, the expression should generally be interpreted in accordance with the meaning of the expression as commonly understood by those skilled in the art (for example, “a system having at least one of A, B, and C” shall include, but not be limited to, a system having A alone, B alone, C alone, A and B, A and C, B and C, and/or B, C, etc.). When an expression like “at least one of A, B, or C, etc.” is used, the expression should generally be interpreted in accordance with the meaning of the expression as commonly understood by those skilled in the art (for example, “a system having at least one of A, B, or C, etc.” shall include, but not be limited to, a system having A alone. B alone, C alone, A and B, A and C, B and C, and/or A, B, C, etc.).

Embodiments of the present disclosure provide a method and apparatus of processing an order information, a computer device, and a medium. The method of processing an order information may include a first acquisition process, a second acquisition process and a model processing process. In the first acquisition process, an order information is acquired, and the order information includes: an information of a designated address and an information of at least one designated item. In the second acquisition process, a warehouse information is acquired, and the warehouse information includes: an inventory information of a plurality of warehouses and a delivery information of the plurality of warehouses. Then, the model processing process is performed, and the order information and the warehouse information are processed by using a pre-built optimization model, so as to determine at least one warehouse from the plurality of warehouses as at least one delivery warehouse according to an output result of the optimization model, so that a sum of a first numerical value and a second numerical value is less than or equal to a predetermined value. The first numerical value is used to characterize a delivery duration taken to deliver the at least one designated item from the at least one delivery warehouse to the designated address, and the second numerical value is used to characterize a delivery fee for delivering the at least one designated item from the at least one delivery warehouse to the designated address.

With a rapid development of Internet technology and a rapid rise of e-commerce, various e-commerce platforms provide a variety of online commodity trading channels, which may greatly facilitate people's work and life. E-commerce fulfillment refers to an entire process from an order generation to a user's receipt of ordered items. A merchant may generally set up several delivery centers in or around a service area, and a plurality of warehouses may be set up in each delivery center to store items for sale. A fulfillment decision means that for each order, one or more warehouses are determined as an actual warehouse for the fulfillment, which is also known as a delivery warehouse, from a plurality of candidate warehouses, and a designated item in the order is delivered from a determined delivery warehouse to a delivery address designated in the order. On the one hand, since a location and inventory level of different warehouses may be different, a choice of the delivery warehouse will directly affect the user's receipt duration, that is, the delivery duration. On the other hand, for the same order, a choice of delivery warehouse will also affect a delivery cost. For example, a plurality of items shipped from the same warehouse may be combined into one package, thereby reducing a logistics cost. In addition, warehousing and delivery costs vary from warehouse to warehouse. Therefore, a result of the fulfillment decision will directly affect a delivery duration and a delivery cost, thereby affecting a user's shopping experience and a merchant's fulfillment cost.

The existing fulfillment decision scheme is mainly to give priority to a high-priority warehouse based on a preset rule according to a delivery address designated by a user or a priority of the warehouse set in advance for a category of purchased items when a performance decision on items in an order is made. When an order contains a plurality of items, the fulfillment decision will give priority to a warehouse that may satisfy all items in the order. If no warehouse that may satisfy the condition is found, based on a preset order splitting algorithm, the order is divided into several sub-orders, each sub-order contains a part of the original order, and then the fulfillment decision is made for each sub-order.

The scheme may not comprehensively balance a user experience and a fulfillment cost. The priority of each warehouse is based on the preset, and does not fully reflect a length of a delivery duration. Even if a high-priority warehouse is selected, it is not necessarily the warehouse has the shortest delivery duration, and a delivery cost is not considered. For example, by a current fulfillment decision method, for an order containing a plurality of items, when there is only one warehouse that may provide all items in the order, the warehouse may be selected as the delivery warehouse for all the items in the order, and whether the delivery duration of the delivery address designated by the warehouse for the order is too long may not be considered. Once the delivery duration of the warehouse is too long, a user experience of the order will be extremely poor. Moreover, when the warehouse that may provide all items in the order is not found, the existing order splitting algorithm may not guarantee a balance and an optimization of the delivery duration and the delivery fee.

According to embodiments of the present disclosure, a method and apparatus of processing an order information are provided, so as to make an order fulfillment decision, and to determine at least one warehouse from a plurality of warehouses as at least one delivery warehouse. The method of processing an order information according to embodiments of the present disclosure may comprehensively weigh a delivery duration and a delivery cost in a fulfillment decision process, so as to further optimize an E-commerce fulfillment decision scheme, and determine a delivery warehouse more in line with actual needs for an order, which may not only improve a user's shopping experience, but also reduce a merchant's fulfillment cost as much as possible.

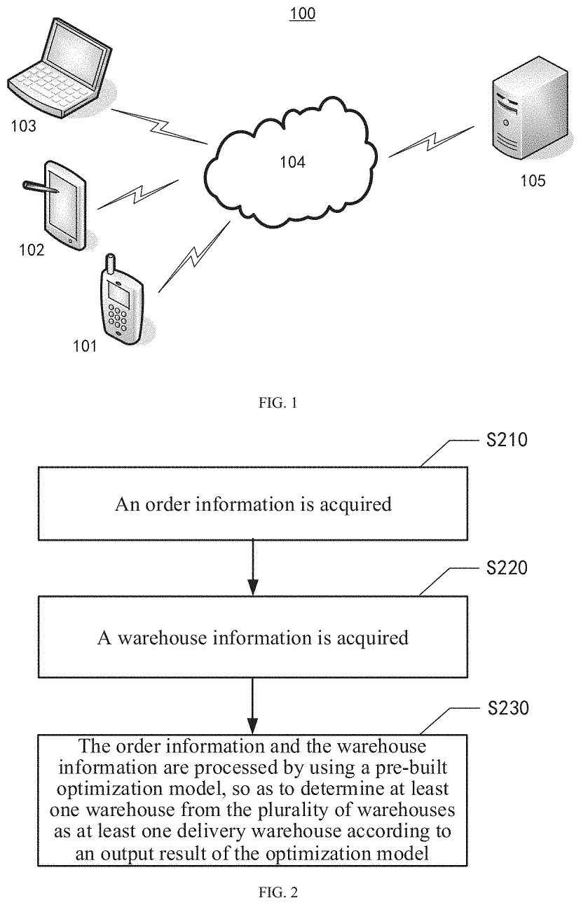

FIG. 1 schematically shows an exemplary system architecture 100 to which a method and apparatus of processing an order information according to an embodiment of the present disclosure may be applied. It should be noted that FIG. 1 shows only an example of a system architecture to which embodiments of the present disclosure may be applied, so as to help those skilled in the art to understand the technical contents of embodiments of the present disclosure, which does not mean that embodiments of the present disclosure may not be applied to other devices, systems, environments or scenarios.

As shown in FIG. 1, the system architecture 100 according to embodiments of the present disclosure may include terminal devices 101, 102, and 103, a network 104, and a server 105. The network 104 is used to provide a medium of communication links between the terminal devices 101, 102, 103 and the server 105. The network 104 may include various connection types, such as wired, wireless communication links, or fiber optic cables, etc.

The terminal devices 101, 102, and 103 are in communication with the server 105 through the network 104 so as to receive or send messages, etc. Client applications with various functions may be installed on the terminal devices 101, 102, 103, such as a shopping application, a web browser application, a search application, an instant messaging tool, an email client, a social platform software, etc. (examples only).

The terminal devices 101, 102, 103 may be various electronic devices, including but not limited to a vehicle navigation, a smart phone, a tablet computer, a laptop computer, a desktop computer, etc.

The server 105 may be a server that provides various services, such as a background management server that provides support for various client applications in the terminal devices 101, 102, and 103. The background management server may receive request messages sent by the terminal devices 101, 102, and 103, respond to, such as analyze and process, the received request messages, and feed back respond results (for example, generated webpage, information, or data, etc. acquired and processed according to the request messages) for the request messages to the terminal devices 101, 102, 103, and then the terminal devices 101, 102, 103 output these response results to a user.

It should be noted that the method of processing an order information according to embodiments of the present disclosure may be implemented in the terminal devices 101, 102, 103, and accordingly, the apparatus of processing an order information according to embodiments of the present disclosure may be provided in the terminal devices 101, 102, 103. Alternatively, the method of processing an order information according to embodiments of the present disclosure may also be implemented in the server 105, and accordingly, the apparatus of processing an order information according to embodiments of the present disclosure may be provided in the server 105. Alternatively, the method of processing an order information according to embodiments of the present disclosure may also be implemented in other computer devices capable of communicating with the terminal devices 101, 102, 103 and/or the server 105, and accordingly, the apparatus of processing an order information according to embodiments of the present disclosure may be provided in other computer devices capable of communicating with the terminal devices 101, 102, 103 and/or the server 105.

It should be understood that the number and types of terminal devices, networks and servers in FIG. 1 are merely illustrative. According to actual needs, there may be any number and type of terminal devices, networks and servers.

According to embodiments of the present disclosure, a method of processing an order information is provided. The method will be exemplarily described below by the drawings. It should be noted that the serial number of each operation in the following method is only used as a representation of the operation for the convenience of description, and should not be regarded as representing an execution order of each operation. Unless explicitly indicated, the method does not need to be performed exactly in an order shown.

FIG. 2 schematically shows a flowchart of a method of processing an order information according to an embodiment of the present disclosure.

As shown in FIG. 2, the method may include operations S210 to S230.

In operation S210, an order information is acquired.

The order information includes: an information of a designated address and an information of at least one designated item.

In operation S220, a warehouse information is acquired.

The warehouse information includes: an inventory information of a plurality of warehouses and a delivery information of the plurality of warehouses.

Then, in operation S230, the order information and the warehouse information are processed by using a pre-built optimization model, so as to determine at least one warehouse from the plurality of warehouses as at least one delivery warehouse according to an output result of the optimization model.

According to embodiments of the present disclosure, for example, a first numerical value is used to characterize a delivery duration taken to deliver the at least one designated item indicated by the order information from the at least one delivery warehouse to the designated address. The delivery duration may be a length of time it takes from an order generation to a delivery of all designated items indicated by the order information to the designated address, or the delivery duration may be a length of time it takes from a start of delivery to a delivery of all designated items indicated by the order information to the designated address. A second numerical value is used to characterize a delivery fee for delivering the at least one designated item indicated by the order information from the at least one delivery warehouse to the designated address. The delivery fee represents a cost that a merchant needs to spend in a delivery process, including, for example, one or more of a transportation cost, a package packaging cost, and a labor cost during a delivery process for all designated items indicated by the order information during the delivery process. The delivery warehouse may be determined from the plurality of warehouses according to the output result of the optimization model so that a sum of the first numerical value and the second numerical value is less than or equal to a predetermined value.

Those skilled in the art may understand that the method of processing an order information according to embodiments of the present disclosure may be implemented to make an order fulfillment decision by using a pre-built optimization model. By using the order information and warehouse information as input features of the optimization model, the delivery warehouse for at least one designated item indicated by the order information is determined according to the output result of the optimization model. A fulfillment decision result of the optimization model may comprehensively weigh the delivery duration and the delivery cost, so that when all designated items indicated by the order information are delivered from the determined one or more delivery warehouses to the designated address, a sum of the first numerical value characterizing the delivery duration and the second numerical value characterizing the delivery tee may be optimized to be less than or equal to the predetermined value as much as possible. Therefore, a user experience and a fulfillment cost may be improved, and needs of both a user and a merchant may be met.

According to embodiments of the present disclosure, the information of each designated item in the at least one designated item may include: an identification information of each designated item and a demand number for each designated item. The inventory information of each warehouse in the plurality of warehouses may include: an identification information of items stored in each warehouse and a storage number of each item in each warehouse. The delivery information of each warehouse in the plurality of warehouses may include: a desired delivery duration of each warehouse for a plurality of addresses and a desired delivery fee of each warehouse.

For example, the identification information of the designated item or item may be a SKU (stock keeping unit) serial number. The desired delivery duration of a warehouse to an address may characterize an expected duration it needs to deliver an item from the warehouse to the address. The desired delivery fee of a warehouse may characterize an expected fee of the warehouse for delivering a package. A package may be packed with one or more items, and a number of each item may be one or more. Exemplarily, the desired delivery duration of each warehouse for each address may be acquired statistically according to historical delivery duration data of the warehouse for the address, or may be predicted according to historical delivery duration data of the warehouse for other addresses near the address; the desired delivery fee of each warehouse may also be acquired statistically according to historical delivery fee data. According to another embodiment of the present disclosure, the warehouse information may further include respective identification information of a plurality of warehouses.

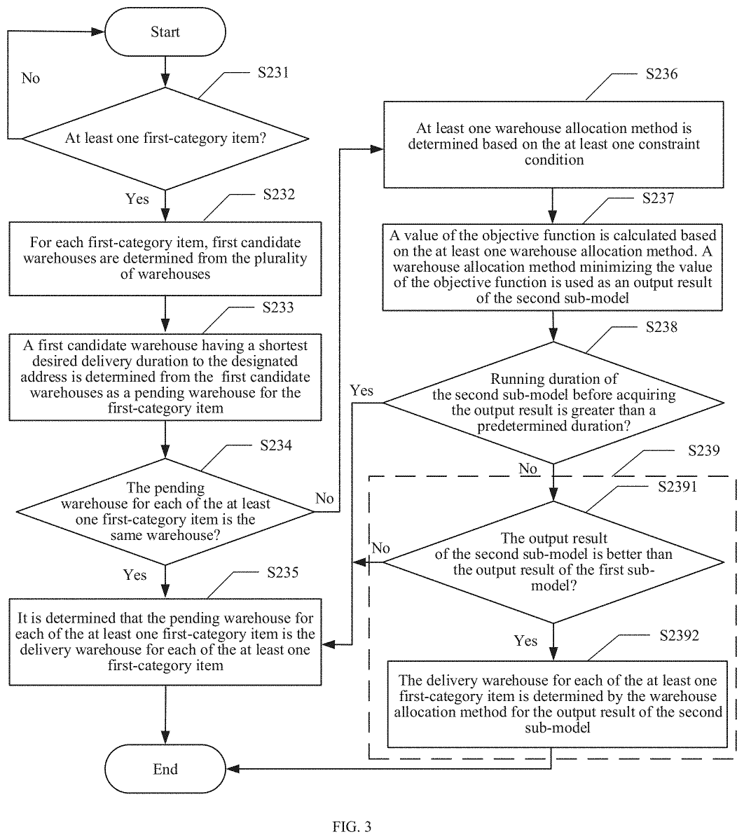

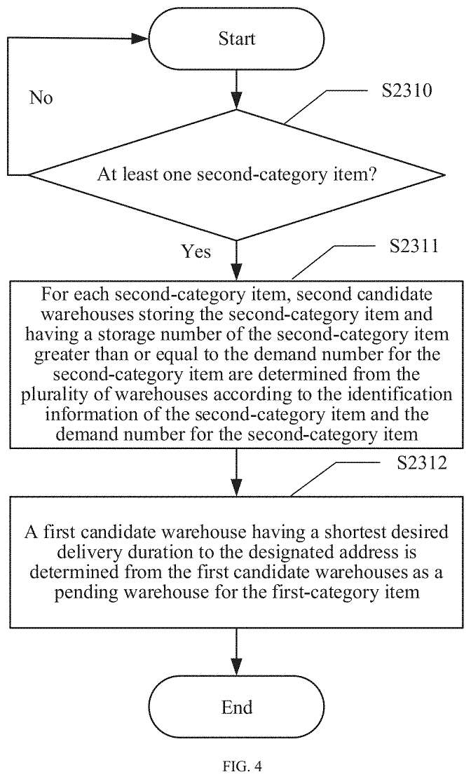

FIG. 3 schematically shows an example flowchart of a method of processing an order information according to another embodiment of the present disclosure, which is used to illustrate an example implementation process of the operation S230 in which the order information and the warehouse information are processed by using a pre-built optimization model, so as to determine at least one warehouse from the plurality of warehouses as at least one delivery warehouse according to an output result of the optimization model.

As shown in FIG. 3, after an execution is started, the method may include operations S231 to S235.

In operation S231, it is determined whether at least one first-category item exists in the at least one designated item indicated by the order information. If so, operation S232 is performed. If not, the process returns to a start state.

Exemplarily, the first-category item may be set as needed. For example, the first-category items may refer to all items that need to be packaged, and may be referred to as “non original packaged items”, that is, items that are not directly delivered in an original packaging. If the first-category item exists in the at least one designated item indicated by the order information, a possibility that part or all of the at least one designated item will be combined and packaged needs to be considered in a process of making a fulfillment decision.

In operation S232, for each first-category item, first candidate warehouses storing the first-category item and having a storage number of the first-category item greater than or equal to the demand number for the first-category item are determined from the plurality of warehouses according to the identification information of the first-category item and the demand number for the first-category item.

Any first-category item A will be exemplarily described below as an example. The order information includes an identification information “A” of the first-category item A and a demand number M of the first-category item A. For the first-category item A, one or more first candidate warehouses for the first-category item A are determined from the plurality of warehouses. Each determined first candidate warehouse stores the first-category item A, and a storage number of the first-category item A stored in each first candidate warehouse is greater than or equal to the demand number M for the first-category item A indicated by the order information. The process of determining the first candidate warehouse may include, for example, performing a matching search in the inventory information of the plurality of warehouses according to the identification information “A” and determining a warehouse including the identification information “A” in the inventory information. Then, a matching search is performed in the inventory information including the identification information “A” according to the demand number M, and a warehouse whose storage number corresponding to the identification information “A” in the inventory information is greater than or equal to M is determined as a first candidate warehouse for the first-category item A.

In operation S233, a first candidate warehouse having a shortest desired delivery duration to the designated address is determined from the first candidate warehouses as a pending warehouse for the first-category item.

Exemplarily, in the operation S233, a desired delivery duration of each of the first candidate warehouses for the designated address indicated by the order information is determined according to the above-determined delivery information of each of the determined first candidate warehouses. The first candidate warehouse having the shortest desired delivery duration to the designated address is used as the pending warehouse for the first-category item. For example, the order information indicates a designated address L and the first-category item A, and it is determined through operation S232 that the first candidate warehouses of the first-category item A include warehouses D₁, D₂ and D₃. According to respective delivery information of the warehouses D₁, D₂ and D₃, it may be known that a desired delivery duration of the warehouse D₁ to the designated address L is t₁, a desired delivery duration of the warehouse D₂ to the designated address L is t₂, and a desired delivery duration of the warehouse D₃ to the designated address L is t₃. If t₂<t₁<t₃, it is determined that the warehouse D₂ is a pending warehouse for the first-category item A. Similarly, when the order information also indicates other first-category items, a pending warehouse for each first-category item may be determined according to the logic.

According to embodiments of the present disclosure, the optimization model may include a first sub-model. The operations S231 to S233 may all be performed by using the first sub-model, and the pending warehouse for each of the at least one first-category item is determined as an output result of the first sub-model.

In operation S234, it is determined whether the pending warehouse for each of the at least one first-category item is the same warehouse. If so, operation S235 is performed.

In operation S235, it is determined that the pending warehouse for each of the at least one first-category item is the delivery warehouse for each of the at least one first-category item.

Exemplarily, when the output result of the first sub-model characterizes that the pending warehouse for the at least one first-category item in the order information is the same warehouse, it is indicated that the same warehouse may provide the at least one first-category item at the same time. If the same warehouse is used as the delivery warehouse for the at least one first-category item, the first-category item may be packaged into the same package, thereby reducing a delivery cost. Since a desired delivery duration for each first-category item in the same warehouse is relatively short, the use of the same warehouse as the delivery warehouse for the at least one first-category item may not lead to an increase in the delivery duration. Therefore, in the operation S234, the delivery warehouse for the at least one first-category item indicated by the order information may be determined according to the output result of the first sub-model, and the pending warehouse is used as the delivery warehouse.

According to embodiments of the present disclosure, the optimization model may further include a second sub-model, and the second sub-model is an integer programming model. An objective function of the integer programming model may characterize the sum of the first numerical value and the second numerical value, that is, a sum of the delivery duration and the delivery fee, and the integer programming model includes at least one constraint condition. As shown in FIG. 3, the operation S230 of processing the order information and the warehouse information by using a pre-built optimization model, so as to determine at least one warehouse from the plurality of warehouses as at least one delivery warehouse according to an output result of the optimization model may further include operations S236 to S239.

When it is determined in the operation S234 that the pending warehouse for each of the at least one first-category item is not the same warehouse, operation S236 is performed by: determining at least one warehouse allocation method based on the at least one constraint condition, the order information and the warehouse information. Each warehouse allocation method may include: a delivery relationship between the at least one first-category item and at least one of the plurality of warehouses. For example, the order information indicates that there are first-category items A₁, A₂ and A₃, and each determined warehouse allocation method may include: a delivery relationship between the first-category item A₁ and one of the plurality of warehouses, a delivery relationship between the first-category item A₂ and one of the plurality of warehouses, and a delivery relationship between the first-category item A₃ and one of the plurality of warehouses.

In operation S237, a value of the objective function is calculated based on the at least one warehouse allocation method. A warehouse allocation method minimizing the value of the objective function is used as an output result of the second sub-model.

Exemplarily, according to the embodiments of the present disclosure, a value range of the first numerical value and the second numerical value may be determined based on the at least one warehouse allocation method, Then, a value of the objective function is calculated based on the value range of the first numerical value and the second numerical value: Next, a warehouse allocation method minimizing the value of the objective function is determined as an output result of the second sub-model.

For example, each warehouse allocation method may include: a delivery relationship between the at least one first-category item and M warehouses, wherein M is an integer greater than or equal to 1. The determining a value range of the first numerical value and the second numerical value based on at least one warehouse allocation method includes: for each warehouse allocation method, determining the first numerical value for each warehouse allocation method according to the desired delivery duration of each of the M warehouses to the designated address; and determining the second numerical value for each warehouse allocation method according to the desired delivery fee of each of the M warehouses.

The process of processing order data and warehouse data by using the integer programming model will be exemplarily described below with reference to specific examples.

For example, the integer programming model may be set as shown in formulas (1) to (7).

$$min {\sum }_{i ∈ I} {\sum }_{j ∈ J} {n}_{i} {t}_{j} {X}_{ij} / n + w \cdot {\sum }_{j ∈ J} {Y}_{j} \qquad ( 1 )$$

$$s . t . {X}_{ij} \leq {s}_{ij} ∀ i ∈ I , j ∈ J \qquad ( 2 )$$

$${\sum }_{j ∈ J} {X}_{ij} = 1 ∀ i ∈ I \qquad ( 3 )$$

$${\sum }_{i ∈ I} {X}_{ij} \geq {Y}_{j} ∀ j ∈ J \qquad ( 4 )$$

$${X}_{ij} \leq {Y}_{j} ∀ i ∈ I , j ∈ J \qquad ( 5 )$$

$${X}_{ij} ∈ \{ 0 , 1 \} ∀ i ∈ I , j ∈ J \qquad ( 6 )$$

$${Y}_{j} ∈ \{ 0 , 1 \} ∀ j ∈ J \qquad ( 7 )$$

Formula (1) indicates that an objective of the integer programming model is to minimize the objective function. Formulas (2) to (7) show constraint conditions of the integer programming model. Exemplarily, i represents an SKU serial number of an item, and I is a set of SKU serial numbers of all designated items in an order information. j represents a number of a warehouse, and J is a set of a plurality of warehouses. A value of sᵢⱼ is used to characterize whether the warehouse j may meet all requirements of the designated item i indicated by the order information. sᵢⱼ=1 represents that the warehouse j meets all requirements of the designated item i, and sᵢⱼ=0 represents that the warehouse j fails to meet all requirements of the designated item i. tⱼ represents a desired delivery duration of the warehouse j. nᵢ represents a demand number for the designated item i indicated by the order information. n represents a total number of all designated items indicated by the order information. w is a weight which may characterize, for example, a desired delivery fee of any warehouse to deliver a package once, and the same weight or different weights may be set for different warehouses. A value of Xᵢⱼ is used to characterize whether the designated item i is delivered by the warehouse j, that is, whether the designated item i has a delivery relationship with the warehouse j. When Xᵢⱼ=1, it is indicated that the designated item i is delivered by the warehouse j, and when Xᵢⱼ=0, it is indicated that the designated item i is not delivered by the warehouse j. A value of Yⱼ is used to characterize whether a designated item delivered by the warehouse j exists in the order information. When Yⱼ=1, the designated item delivered by the warehouse j exists, and when Yⱼ=0, the designated item delivered by the warehouse j does not exist. Formula (1) characterizes a minimization of an average desired delivery duration and an average desired delivery fee. In this example, the average desired delivery fee is equal to a weighted sum of the number of split orders. The constraint condition of formula (2) restricts that each item (e.g. uniquely identified by a SKU serial number) may be delivered by only a warehouse capable of meeting all demand numbers for the item. The constraint condition of formula (3) restricts that each item may be delivered by only one warehouse. The constraint conditions of formulas (4) and (5) restrict that a warehouse may be an actual delivery warehouse only when the warehouse delivers at least one item. The constraint conditions of formulas (6) and (7) restrict that the Xᵢⱼ and Yⱼ are variables in an interval of [0-1].

It may be understood that, according to embodiments of the present disclosure, the at least one constraint condition is used to limit at least one of: a number of the delivery warehouse for each first-category item; the storage number of each first-category item in the delivery warehouse for each first-category item; and a number of first-category items delivered from each warehouse. Through the integer programming model, several warehouse delivery methods may be defined. Within the limited range, an optimal output result, may be determined according to the objective function.

Continuing to refer to FIG. 3, in operation S238, it is determined whether a running duration of the second sub-model before acquiring the output result is greater than a predetermined duration. If so, the process returns to operation S235. If not, operation S239 is performed.

In operation S239, the delivery warehouse for each of the at least one first-category item is determined according to the output result of the second sub-model.

According to embodiments of the present disclosure, operation S239 may be performed by: in operation S2391, determining whether the output result of the second sub-model is better than the output result of the first sub-model. If so, operation S2392 is performed. If not, the process returns to operation S235. In operation S2392, the delivery, warehouse for each of the at least one first-category item is determined by the warehouse allocation method for the output result of the second sub-model.

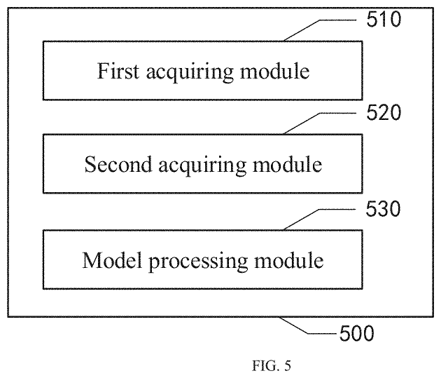

FIG. 4 schematically shows an example flowchart of a method of processing an order information according to another embodiment of the present disclosure, which is used to illustrate another example implementation process of the operation S230 in which the order information and the warehouse information are processed by using a pre-built optimization model, so as to determine at least one warehouse from the plurality of warehouses as at least one delivery warehouse according to an output result of the optimization model.

As shown in FIG. 4, after an execution is started, the method may include operations S2310 to S2312.

In operation S2310, it is determined whether at least one second-category item exists in the at least one designated item. If so, operation S2311 is performed. If not, the process returns to a start state.

Exemplarily, the second-category item may be set as needed. For example, the second-category items may refer to all items that do not need to be packaged, and may be referred to as “original packaged items”, that is, items that may be directly delivered in an original packaging. If the second-category item exists in the at least one designated item indicated by the order information, a possibility that these second-category items are combined and packaged may not be considered in a process of making a fulfillment decision.

In operation S2311, for each second-category item, second candidate warehouses storing the second-category item and having a storage number of the second-category item greater than or equal to the demand number for the second-category item are determined from the plurality of warehouses according to the identification information of the second-category item and the demand number for the second-category item.

In operation S2312, a second candidate warehouse having a shortest desired delivery duration to the designated address is determined from the second candidate warehouses as a delivery warehouse for the second-category item.

The operations S2311 to S2312 have the same implementation principles as those of the operations S232 to S233, and will not be repeated here. After the second candidate warehouse having the shortest desired delivery duration for the second-category item is determined, the second candidate warehouse may be directly used as the delivery warehouse for the second-category item.

According to embodiments of the present disclosure, the optimization model may further include a third sub-model. The operations S2310 to S2312 may all be performed by using the third sub-model, and the delivery warehouse for each of the determined at least one second-category item is used as an output result of the third sub-model. Therefore, the delivery warehouse for each of the at least one second-category item may be determined according to the output result of the third sub-model.

FIG. 5 schematically shows a block diagram of an apparatus of processing an order information according to an embodiment of the present disclosure.

As shown in FIG. 5, the apparatus 500 of processing an order information may include: a first acquiring module 510, a second acquiring module 520 and a model processing module 530.

The first acquiring module 510 is configured to acquire an order information, and the order information includes: an information of a designated address and an information of at least one designated item.

The second acquiring module 520 is configured to acquire a warehouse information, and the warehouse information includes: an inventory information of a plurality of warehouses and a delivery information of the plurality of warehouses.

The model processing module 530 is configured to process the order information and the warehouse information by using a pre-built optimization model, so as to determine at least one warehouse from the plurality of warehouses as at least one delivery warehouse according to an output result of the optimization model, so that a sum of a first numerical value and a second numerical value is less than or equal to a predetermined value. The first numerical value is used to characterize a delivery duration taken to deliver the at least one designated item from the at least one delivery warehouse to the designated address, and the second numerical value is used to characterize a delivery fee for delivering the at least one designated item from the at least one delivery warehouse to the designated address.

It should be noted that the implementations, the technical problems solved, the functions realized, and the technical effects achieved of each module/unit/sub-unit, etc. in some embodiments of the apparatus are respectively the same as or similar to the implementations, the technical problem solved, the function realized, and the technical effect achieved of corresponding steps in some embodiments of the method, and will not be repeated here.

Any number of or at least some functions of any number of modules, sub-modules, units, sub-units according to embodiments of the present disclosure may be implemented in one module. Any one or more of the modules, sub-modules, units, and sub-units according to embodiments of the present disclosure may be implemented by being divided into a plurality of modules. Any one or more of modules, sub-modules, units, sub-units according to embodiments of the present disclosure may be at least partially implemented as a hardware circuit, such as a field programmable gate array (FPGA), a programmable logic array (PLA), a system-on-chip, a system-on-substrate, a system-on-package, an application-specific integrated circuit (ASIC), or may be implemented by any other reasonable means of hardware or firmware that may be integrated or packaged with a circuit, or may be implemented in any one of or an appropriate combination of any of the three implementations, i.e., software, hardware, and firmware. Alternatively, one or more of modules, sub-modules, units, and sub-units according to embodiments of the present disclosure may be at least partially implemented as computer program modules that, when executed, may perform corresponding functions.

For example, any plurality of the first acquiring module 510, the second acquiring module 520, and the model processing module 530 may be combined and implemented in one module, or any of the modules may be split into a plurality of modules. Alternatively, at least some functions of one or more of these modules may be combined with at least some functions of other modules, and implemented in one module. According to embodiments of the present disclosure, at least one of the first acquiring module 510, the second acquiring module 520 and the model processing module 530 may be at least partially implemented as a hardware circuit, such as a field programmable gate array (FPGA), a programmable logic array (PLA), a system-on-chip, a system-on-substrate, a system-on-package, an application-specific integrated circuit (ASIC), or may be implemented by any other reasonable means of hardware or firmware that may be integrated or packaged with a circuit, or may be implemented in any one of or an appropriate combination of any of the three implementations, i.e., software, hardware, and firmware. Alternatively, at least one of the first acquiring module 510, the second acquiring module 520, and the model processing module 530 may be at least partially implemented as a computer program module that, when executed, may perform corresponding functions.

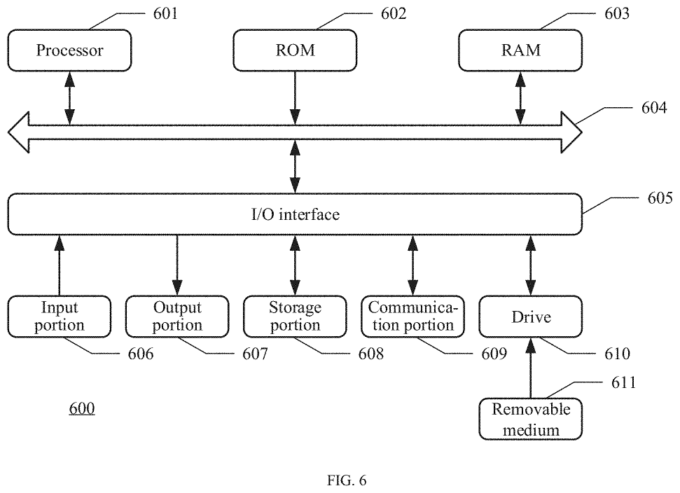

FIG. 6 schematically shows a block diagram of a computer device suitable for implementing a model training method and/or a map drawing method described above according to an embodiment of the present disclosure. The computer device shown in FIG. 6 is only an example, and should not impose any limitation on functions and scope of use of embodiments of the present disclosure.

As shown in FIG. 6, a computer device 600 according to embodiments of the present disclosure includes a processor 601 that may perform various appropriate actions and processes according to a program stored in a read only memory (ROM) 602 or a program loaded from a storage portion 608 into a random access memory (RAM) 603. The processor 601 may include, for example, a general-purpose microprocessor (e.g., a CPU), an instruction set processor and/or a related chipset, and/or a dedicated-purpose microprocessor (e.g., an application-specific integrated circuit (ASIC)), etc. The processor 601 may also include an on-board memory for caching purposes. The processor 601 may include a single processing unit or a plurality of processing units for performing different actions of the method flow according to embodiments of the present disclosure.

In the RAM 603, various programs and data necessary for the operation of the device 600 are stored. The processor 601, the ROM 602 and the RAM 603 are connected to each other through a bus 604. The processor 601 performs various operations of the method flow according to embodiments of the present disclosure by executing the programs in the ROM 602 and/or the RAM 603. It should be noted that the program may also be stored in one or more memories other than the ROM 602 and the RAM 603. The processor 601 may also perform various operations of the method flow according to embodiments of the present disclosure by executing programs stored in the one or more memories.

According to embodiments of the present disclosure, the device 600 may also include an input/output (I/O) interface 605 that is also connected to the bus 604. The device 600 may also include one or more of the following components connected to the I/O interface 605: an input portion 606 including a keyboard, a mouse, etc.; an output portion 607 including a cathode ray tube (CRT), a liquid crystal display (LCD), etc., and a speaker, etc.; a storage portion 608 including a hard disk, etc.; and a communication portion 609 including a network interface card such as a LAN card, a modem, etc. The communication portion 609 performs a communication processing via a network such as the Internet. A drive 610 is also connected to the 110 interface 605 as needed. A removable medium 611, such as a magnetic disk, an optical disk, a magneto-optical disk, a semiconductor memory, etc., is installed on the drive 610 as needed, so that a computer program read therefrom is installed into the storage portion 608 as needed.

According to embodiments of the present disclosure, the method flow according to embodiments of the present disclosure may be implemented as a computer software program. For example, embodiments of the present disclosure include a computer program product including a computer program carried on a computer-readable storage medium, and the computer program contains a program code for performing the method illustrated in the flowchart. In the embodiment, the computer program may be downloaded and installed from the network through the communication portion 609 and/or installed from the removable medium 611. The computer program, when executed by the processor 601, performs the functions defined in the system of embodiments of the present disclosure. According to embodiments of the present disclosure, the systems, devices, apparatuses, modules, units, etc. may be implemented by computer program modules.

Embodiments of the present disclosure further provide a computer-readable storage medium. The computer-readable storage medium may be included in the device/apparatus/system described in the embodiments; or may exist alone without being assembled into the device/apparatus/system. The computer-readable storage medium carries one or more programs, and when the one or more programs are executed, the model training method and/or the map drawing method according to embodiments of the present disclosure is implemented.

According to embodiments of the present disclosure, the computer-readable storage medium may be a non-volatile computer-readable storage medium, such as, but not limited to, a portable computer disk, a hard disk, a random access memory (RAM), a read only memory (ROM), an erasable programmable read only memory (EPROM or flash memory), a portable compact disk read only memory (CD-ROM), an optical storage device, a magnetic storage device, or any suitable combination thereof. In embodiments of the present disclosure, the computer-readable storage medium may be any tangible medium that contains or stores a program that may be used by or in conjunction with an instruction execution system, apparatus, or device. For example, according to embodiments of the present disclosure, the computer-readable storage medium may include one or more memories other than the ROM 602 and/or RAM 603 and/or ROM 602 and RAM 603.

The flowcharts and block diagrams in the accompanying drawings illustrate the architecture, functions, and operations of possible implementations of systems, methods and computer program products according to various embodiments of the present disclosure. In this regard, each block in the flowcharts or block diagrams may represent a module, a segment, or a portion of code that contains one or more executable instructions for implementing designated logical functions should also be noted that, in some alternative implementations, functions noted in the blocks may occur out of the order noted in the accompanying drawings. For example, two blocks shown in succession may, in fact, be executed substantially in parallel, and sometimes the blocks may be executed in a reverse order, depending upon functions involved. It should also be noted that each block of the block diagrams or flowcharts and a combination of blocks in the block diagrams or flowcharts may be implemented with a dedicated hardware-based system that or may be implemented using a combination of dedicated hardware and computer instructions.

Those skilled in the art will appreciate that various combinations and/or incorporations of features recited in various embodiments and/or claims of the present disclosure may be made, even if such combinations or incorporations are not explicitly recited in the present disclosure. In particular, without departing from the spirit and principles of the present disclosure, various combinations and/or incorporations of the features recited in the various embodiments and/or claims of the present disclosure may be made. All of the combinations and/or incorporations fall within the scope of the present disclosure.

1. A method of processing an order information, comprising:
acquiring the order information, wherein the order information comprises: an information of a designated address and an information of at least one designated item;
acquiring a warehouse information, wherein the warehouse information comprises:
an inventory information of a plurality of warehouses and a delivery information of the plurality of warehouses; and
processing the order information and the warehouse information by using a pre-built optimization model, so as to determine at least one warehouse from the plurality of warehouses as at least one delivery warehouse according to an output result of the optimization model, so that a sum of a first numerical value and a second numerical value is less than or equal to a predetermined value,
wherein the first numerical value is used to characterize a delivery duration taken to deliver the at least one designated item from the at least one delivery warehouse to the designated address, and the second numerical value is used to characterize a delivery fee for delivering the at least one designated item from the at least one delivery warehouse to the designated address.

2. The method according to claim 1, wherein
the information of each designated item in the at least one designated item comprises: an identification information of each designated item and a demand number for each designated item;
the inventory information of each warehouse in the plurality of warehouses comprises: an identification information of items stored in each warehouse and a storage number of each item in each warehouse; and
the delivery information of each warehouse in the plurality of warehouses comprises: a desired delivery duration of each warehouse for a plurality of addresses and a desired delivery fee of each warehouse.

3. The method according to claim 2, wherein the optimization model comprises a first sub-model;
the processing the order information and the warehouse information by using a pre-built optimization model comprises: by using the first sub-model,
when at least one first-category item exists in the at least one designated item, for each first-category item, determining, from the plurality of warehouses, first candidate warehouses storing the first-category item and having a storage number of the first-category item greater than or equal to the demand number for the first-category item according to the identification information of the first-category item and the demand number for the first-category item, and determining, from the first candidate warehouses, a first candidate warehouse having a shortest desired delivery duration to the designated address, as a pending warehouse for the first-category item; and
determining the pending warehouse for each of the at least one first-category item as an output result of the first sub-model.

4. The method according to claim 3, wherein the determining at least one warehouse from the plurality of warehouses as at least one delivery warehouse according to an output result of the optimization model comprises:
when the pending warehouse for each of the at least one first-category item is the same warehouse, determining the pending warehouse for each of the at least one first-category item as the delivery warehouse for each of the at least one first-category item.

5. The method according to claim 3, wherein the optimization model further comprises a second sub-model, the second sub-model is an integer programming model, an objective function of the integer programming model characterizes the sum of the first numerical value and the second numerical value, and the integer programming model comprises at least one constraint condition; and
the processing the order information and the warehouse information by using a pre-built optimization model further comprises:
when the pending warehouse for each of the at least one first-category item is not the same warehouse, determining at least one warehouse allocation method based on the at least one constraint condition, the order information and the warehouse information, wherein each warehouse allocation method comprises: a delivery relationship between the at least one first-category item and at least one of the plurality of warehouses;
determining a value range of the first numerical value and the second numerical value based on the at least one warehouse allocation method;
calculating a value of the objective function based on the value range of the first numerical value and the second numerical value; and
determining a warehouse allocation method minimizing the value of the objective function as an output result of the second sub-model.

6. The method according to claim 5, wherein the determining at least one warehouse from the plurality of warehouses as at least one delivery warehouse according to an output result of the optimization model further comprises:
determining whether a running duration of the second sub-model before acquiring the output result is greater than a predetermined duration;
in a case that the running duration of the second sub-model before acquiring the output result is greater than the predetermined duration, determining the pending warehouse for each of the at least one first-category item as the delivery warehouse for each of the at least one first-category item; and
in a case that the running duration of the second sub-model before acquiring the output result is not greater than the predetermined duration, determining the delivery warehouse for each of the at least one first-category item according to the output result of the second sub-model.

7. The method according to claim 5, wherein each warehouse allocation method comprises: a delivery relationship between the at least one first-category item and M warehouses, wherein M is an integer greater than or equal to 1; and
the determining a value range of the first numerical value and the second numerical value based on the at least one warehouse allocation method comprises:
for each warehouse allocation method,
determining the first numerical value for each warehouse allocation method according to the desired delivery duration of each of the M warehouses to the designated address; and
determining the second numerical value for each warehouse allocation method according to the desired delivery fee of each of the M warehouses.

8. The method according to claim 5, wherein the at least one constraint condition is used to limit at least one of:
a number of the delivery warehouse for each first-category item;
the storage number of each first-category item in the delivery warehouse for each first-category item; and
a number of first-category items delivered from each warehouse.

9. The method according to claim 3, wherein the optimization model further comprises a third sub-model;
the processing the order information and the warehouse information by using a pre-built optimization model further comprises: by using the third sub-model,
when at least one second-category item exists in the at least one designated item, for each second-category item, determining, from the plurality of warehouses, second candidate warehouses storing the second-category item and having a storage number of the second-category item greater than or equal to the demand number for the second-category item according to the identification information of the second-category item and the demand number for the second-category item, and determining, from the second candidate warehouses, a second candidate warehouse having a shortest desired delivery duration to the designated address as a delivery warehouse for the second-category item;
determining the delivery warehouse for each of the at least one second-category item as an output result of the third sub-model.

10. The method according to claim 9, wherein the determining at least one warehouse from the plurality of warehouses as at least one delivery warehouse according to an output result of the optimization model further comprises:
determining the delivery warehouse for each of the at least one second-category item according to the output result of the third sub-model.

11. (canceled)

12. A computer device, comprising:
a memory having computer instructions stored thereon; and
at least one processor;
wherein the processor, when executing the computer instructions, is configured to:
acquire the order information, wherein the order information comprises: an information of a designated address and an information of at least one designated item;
acquire a warehouse information, wherein the warehouse information comprises: an inventory information of a plurality of warehouses and a delivery information of the plurality of warehouses; and
process the order information and the warehouse information by using a pre-built optimization model, so as to determine at least one warehouse from the plurality of warehouses as at least one delivery warehouse according to an output result of the optimization model, so that a sum of a first numerical value and a second numerical value is less than or equal to a predetermined value,
wherein the first numerical value is used to characterize a delivery duration taken to deliver the at least one designated item from the at least one delivery warehouse to the designated address, and the second numerical value is used to characterize a delivery fee for delivering the at least one designated item from the at least one delivery warehouse to the designated address.

13. A non-transitory computer-readable storage medium having computer instructions stored thereon, wherein the computer instructions, when executed by a processor, is configured to:
acquire the order information, wherein the order information comprises: an information of a designated address and an information of at least one designated item;
acquire a warehouse information, wherein the warehouse information comprises: an inventory information of a plurality of warehouses and a delivery information of the plurality of warehouses; and
process the order information and the warehouse information by using a pre-built optimization model, so as to determine at least one warehouse from the plurality of warehouses as at least one delivery warehouse according to an output result of the optimization model, so that a sum of a first numerical value and a second numerical value is less than or equal to a predetermined value,
wherein the first numerical value is used to characterize a delivery duration taken to deliver the at least one designated item from the at least one delivery warehouse to the designated address, and the second numerical value is used to characterize a delivery fee for delivering the at least one designated item from the at least one delivery warehouse to the designated address.

14. The method according to claim 4, wherein the optimization model further comprises a second sub-model, the second sub-model is an integer programming model, an objective function of the integer programming model characterizes the sum of the first numerical value and the second numerical value, and the integer programming model comprises at least one constraint condition; and
the processing the order information and the warehouse information by using a pre-built optimization model further comprises:
when the pending warehouse for each of the at least one first-category item is not the same warehouse, determining at least one warehouse allocation method based on the at least one constraint condition, the order information and the warehouse information, wherein each warehouse allocation method comprises: a delivery relationship between the at least one first-category item and at least one of the plurality of warehouses;
determining a value range of the first numerical value and the second numerical value based on the at least one warehouse allocation method;
calculating a value of the objective function based on the value range of the first numerical value and the second numerical value; and
determining a warehouse allocation method minimizing the value of the objective function as an output result of the second sub-model.

15. The method according to claim 14, wherein the determining at least one warehouse from the plurality of warehouses as at least one delivery warehouse according to an output result of the optimization model further comprises:
determining whether a running duration of the second sub-model before acquiring the output result is greater than a predetermined duration;
in a case that the running duration of the second sub-model before acquiring the output result is greater than the predetermined duration, determining the pending warehouse for each of the at least one first-category item as the delivery warehouse for each of the at least one first-category item; and
in a case that the running duration of the second sub-model before acquiring the output result is not greater than the predetermined duration, determining the delivery warehouse for each of the at least one first-category item according to the output result of the second sub-model.

16. The method according to claim 14, wherein each warehouse allocation method comprises: a delivery relationship between the at least one first-category item and M warehouses, wherein M is an integer greater than or equal to 1; and
the determining a value range of the first numerical value and the second numerical value based on the at least one warehouse allocation method comprises:
for each warehouse allocation method,
determining the first numerical value for each warehouse allocation method according to the desired delivery duration of each of the M warehouses to the designated address; and
determining the second numerical value for each warehouse allocation method according to the desired delivery fee of each of the M warehouses.

17. The method according to claim 14, wherein the at least one constraint condition is used to limit at least one of:
a number of the delivery warehouse for each first-category item;
the storage number of each first-category item in the delivery warehouse for each first-category item; and
a number of first-category items delivered from each warehouse.

18. The computer device according to claim 12, wherein
the information of each designated item in the at least one designated item comprises: an identification information of each designated item and a demand number for each designated item;
the inventory information of each warehouse in the plurality of warehouses comprises: an identification information of items stored in each warehouse and a storage number of each item in each warehouse; and
the delivery information of each warehouse in the plurality of warehouses comprises: a desired delivery duration of each warehouse for a plurality of addresses and a desired delivery fee of each warehouse.

19. The computer device according to claim 18, wherein the optimization model comprises a first sub-model;
the processor is further configured to: by using the first sub-model,
when at least one first-category item exists in the at least one designated item, for each first-category item, determine, from the plurality of warehouses, first candidate warehouses storing the first-category item and having a storage number of the first-category item greater than or equal to the demand number for the first-category item according to the identification information of the first-category item and the demand number for the first-category item, and determine, from the first candidate warehouses, a first candidate warehouse having a shortest desired delivery duration to the designated address, as a pending warehouse for the first-category item; and
determine the pending warehouse for each of the at least one first-category item as an output result of the first sub-model.

20. The computer device according to claim 19, wherein the processor is further configured to:
when the pending warehouse for each of the at least one first-category item is the same warehouse, determine the pending warehouse for each of the at least one first-category item as the delivery warehouse for each of the at least one first-category item.

21. The computer device according to claim 19, wherein the optimization model further comprises a second sub-model, the second sub-model is an integer programming model, an objective function of the integer programming model characterizes the sum of the first numerical value and the second numerical value, and the integer programming model comprises at least one constraint condition; and
the processor is further configured to:
when the pending warehouse for each of the at least one first-category item is not the same warehouse, determine at least one warehouse allocation method based on the at least one constraint condition, the order information and the warehouse information, wherein each warehouse allocation method comprises: a delivery relationship between the at least one first-category item and at least one of the plurality of warehouses;
determine a value range of the first numerical value and the second numerical value based on the at least one warehouse allocation method;
calculate a value of the objective function based on the value range of the first numerical value and the second numerical value; and
determine a warehouse allocation method minimizing the value of the objective function as an output result of the second sub-model.
